(19) United States
(12) Patent Application Publication
(10) Pub. No.: US 2024/0329284 A1
(43) Pub. Date: Oct. 3, 2024

(54) High Contrast Grating Polarizer

(71) Applicant: ZHEJIANG BERXEL PHOTONICS CO., LTD., Jiaxing City (CN)

(72) Inventors: Yao CUI, Jiaxing City (CN); Constance Jui-hua CHANG-HASNAIN, Jiaxing City (CN); Jonas Horst KAPRAUN, Jiaxing City (CN); Yipeng JI, Jiaxing City (CN)

(21) Appl. No.: 18/138,393

(22) Filed: Apr. 24, 2023

(30) Foreign Application Priority Data
Mar. 31, 2023 (CN) 202310359461.7

(51) Int. Cl. G02B 5/00; G02B 5/18; G02B 5/30

(52) U.S. Cl. CPC G02B 5/008; G02B 5/1861; G02B 5/3058

(57) ABSTRACT

Provided is a high contrast grating polarizer, which relates to the technical field of photoelectric devices. The polarizer includes a substrate, a high contrast grating on the substrate and a plasmonic metal antenna structure interleaved with the high contrast grating, where the high contrast grating includes a semiconductor grating or a dielectric grating; and the high contrast grating is configured to transmit light of a first polarization direction, the plasmonic metal antenna structure is configured to reflect light of a second polarization direction, and the first polarization direction is opposite to the second polarization direction.

### CROSS REFERENCE TO RELATED APPLICATION

The present disclosure claims the benefit of priorities to Chinese patent application No. 202310359461.7, filed on Mar. 31, 2023 to China National Intellectual Property Administration and entitled “High Contrast Grating Polarizer”, which is incorporated herein by reference in its entirety.

### TECHNICAL FIELD

The present disclosure generally relates to the technical field of photoelectric devices, in particular to a high contrast grating polarizer.

### BACKGROUND

Polarizer is an optical filter that allows light waves of a particular polarization direction to pass through while blocking light waves in other polarization directions. According to different working principles, commercial polarizers can be divided into two categories: one is thin film polarizer and the other is wire-grid polarizer. The thin film polarizer is to arrange the molecular chains of organic compounds along a specific direction, while the wire-grid polarizer is to etch a metal grating periodically on glass and use Maxwell's equations to solve the boundary condition of structure. Compared with thin film polarizers, wire-grid polarizers have higher transmittance, higher extinction ratio, and larger operating temperature range.

However, the difficult fabrication process and high price of wire-grid polarizers in related technologies restrict mass production. According to the principles of metal acting on electromagnetic waves, electromagnetic waves can only interact with it on the surface of metal. For most metals, this skin depth is about 10 nm, but the thickness of the current metal grating is generally about 100-300 nm (thicker metal grating is just to support the specific structure of the grating. The metal inside does not have any photoelectric action), so there is a large waste of material, and the difficulty of fabrication is also greatly increased.

### SUMMARY

In view of the above shortcomings or deficiencies in related technologies, it is desirable to provide a high contrast grating polarizer with a simple structure and low cost.

The present disclosure provides a high contrast grating polarizer, including:

a substrate; and

a high contrast grating on the substrate and a plasmonic metal antenna structure interleaved with the high contrast grating, where the high contrast grating includes a semiconductor grating or a dielectric grating; and the high contrast grating is configured to transmit light of a first polarization direction, the plasmonic metal antenna structure is configured to reflect light of a second polarization direction, and the first polarization direction is opposite to the second polarization direction.

In some embodiments of the present disclosure, the plasmonic metal antenna structure is located in at least one of the bottom, left sidewall and right sidewall of a high contrast grating gap.

In some embodiments of the present disclosure, the plasmonic metal antenna structure is located on the top, left sidewall and right sidewall of each high contrast grating bar; or the plasmonic metal antenna structure is located on the top of each high contrast grating bar.

In some embodiments of the present disclosure, a first adhesive layer is further provided between the substrate and the high contrast grating, and/or between the substrate and the plasmonic metal antenna structure.

In some embodiments of the present disclosure, the first adhesive layer includes any one of a SiN layer, an Al₂O₃ layer, and a SiO₂ layer.

In some embodiments of the present disclosure, a second adhesive layer is further provided between the plasmonic metal antenna structure and the high contrast grating, and/or between the plasmonic metal antenna structure and the first adhesive layer.

In some embodiments of the present disclosure, the second adhesive layer includes any one of a Ti layer, a Ge layer, and an Al layer.

In some embodiments of the present disclosure, the outer surface of the high contrast grating and the outer surface of the plasmonic metal antenna structure are covered with a protective layer.

In some embodiments of the present disclosure, grooves of the plasmonic metal antenna structure and/or grooves formed by gaps between the plasmonic metal antenna structure and the high contrast grating are further filled with the protective layer, respectively.

In some embodiments of the present disclosure, the protective layer includes any one of a SiN layer, an Al₂O₃ layer, and a SiO₂ layer.

It can be seen from the foregoing technical solution that the embodiments of the present disclosure have the following advantages:

The embodiments of the present disclosure provide a high contrast grating polarizer, in which the high contrast grating is made by semiconductor or dielectric material to replace most metal materials, so the production cost can be greatly decreased; and the plasmonic metal antenna structure interleaved with the high contrast grating can also reduce the grating thickness, so the structure is simple, the fabrication is easy, and meanwhile, the performance is still very close to the traditional wire-grid polarizer.

### BRIEF DESCRIPTION OF FIGURES

Other features, objectives and advantages of the present disclosure will become more apparent by reading the detailed description of non-limiting embodiments with reference to the accompanying drawings below.

FIG. 1 is a schematic structural diagram of a high contrast grating polarizer according to an embodiment of the present disclosure;

FIG. 2 is a schematic diagram of S-polarized light incident on a high contrast grating polarizer according to an embodiment of the present disclosure;

FIG. 3 is a schematic diagram of E-field simulation of S-polarized light with ϑ equal to 0 deg and φ equal to 90 deg according to an embodiment of the present disclosure;

FIG. 4 is a schematic diagram of P-polarized light incident on the high contrast grating polarizer according to an embodiment of the present disclosure;

FIG. 5 is a schematic diagram of E-field simulation of P-polarized light with ϑ equal to 0 deg and φ equal to 90 deg according to an embodiment of the present disclosure;

FIG. 6 is an electron microscope image of a polarizer according to an embodiment of the present disclosure;

FIG. 7 is a schematic structural diagram of another high contrast grating polarizer according to an embodiment of the present disclosure;

FIG. 8 is a schematic structural diagram of another high contrast grating polarizer according to an embodiment of the present disclosure;

FIG. 9 is a schematic structural diagram of another high contrast grating polarizer according to an embodiment of the present disclosure;

FIG. 10 is a schematic structural diagram of yet another high contrast grating polarizer according to an embodiment of the present disclosure;

FIG. 11 is a schematic structural diagram of yet another high contrast grating polarizer according to an embodiment of the present disclosure;

FIG. 12 is a schematic structural diagram of yet another high contrast grating polarizer according to an embodiment of the present disclosure;

FIG. 13 is a schematic structural diagram of still another high contrast grating polarizer according to an embodiment of the present disclosure;

FIG. 14 is a schematic structural diagram of still another high contrast grating polarizer according to an embodiment of the present disclosure;

FIG. 15 is a schematic structural diagram of a high contrast grating polarizer according to another embodiment of the present disclosure;

FIG. 16 is a schematic structural diagram of another high contrast grating polarizer according to another embodiment of the present disclosure;

FIG. 17 is a schematic structural diagram of another high contrast grating polarizer according to another embodiment of the present disclosure;

FIG. 18 is a schematic structural diagram of still another high contrast grating polarizer according to another embodiment of the present disclosure;

FIG. 19 is a schematic structural diagram of a high contrast grating polarizer according to another embodiment of the present disclosure;

FIG. 20 is a schematic structural diagram of another high contrast grating polarizer according to another embodiment of the present disclosure; and

FIG. 21 is a schematic structural diagram of still another high contrast grating polarizer according to another embodiment of the present disclosure.

### REFERENCE NUMERALS

100—high contrast grating polarizer, 101—substrate, 102—high contrast grating, 103—plasmonic metal antenna structure, 104—first adhesive layer, 105—second adhesive layer, 106—protective layer, 107—gap, and 108—air hole.

### DETAILED DESCRIPTION

To make a person skilled in the art understand the solutions in the present disclosure better, the following clearly and completely describes the technical solutions in the embodiments of the present disclosure with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without any creative efforts shall fall within the protection scope of the present disclosure.

In the specification and claims of the present disclosure and the foregoing accompanying drawings, the terms “first”, “second”, “third”, “fourth”, and the like (if any) are intended to distinguish between similar objects, but do not necessarily describe a specific order or sequence. It should be understood that the data used in this way is interchangeable in appropriate circumstances, so that the described embodiments of the present disclosure can be implemented in other orders than the order illustrated or described herein.

Moreover, the terms “include”, “contain” and any other variants mean to cover the non-exclusive inclusion. For example, a process, method, system, product, or device that includes a list of steps or modules is not necessarily limited to those expressly listed steps or modules, but may include other steps or modules not expressly listed or inherent to such a process, method, product, or device.

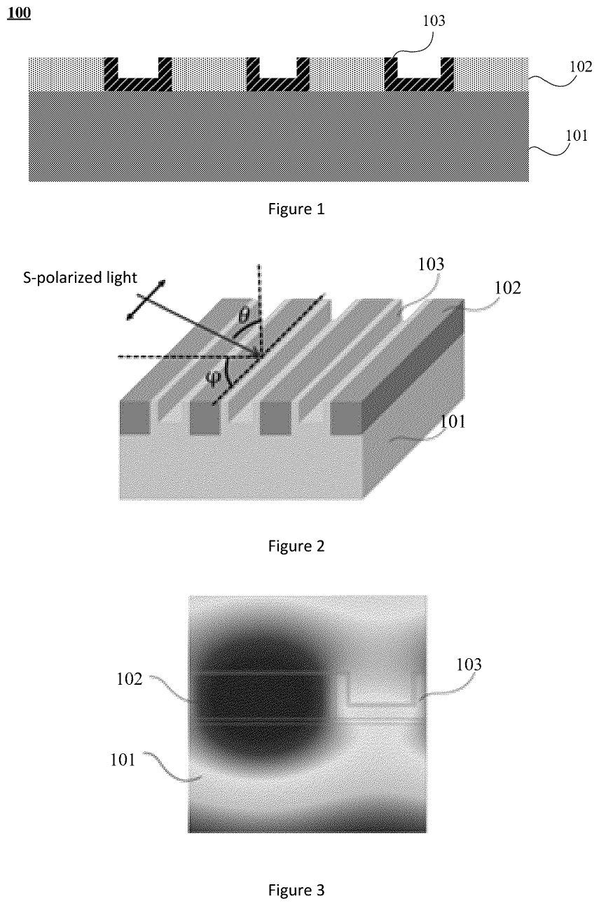

For ease of understanding and explanation, a high contrast grating polarizer according to embodiments of the present disclosure is described in detail below through FIG. 1 to FIG. 21.

Refer to FIG. 1, which is a schematic structural diagram of a high contrast grating polarizer according to an embodiment of the present disclosure. The high contrast grating polarizer 100 includes a substrate 101, a high contrast grating (HCG) 102 on the substrate 101 and a plasmonic metal antenna structure 103 interleaved with the high contrast grating 102, where the high contrast grating 102 can transmit light of a first polarization direction, the plasmonic metal antenna structure 103 can reflect light of a second polarization direction, and the first polarization direction is opposite to the second polarization direction. For example, polarized light includes, but is not limited to, S-polarized light, P-polarized light, circularly polarized light, elliptically polarized light, or the like. Transmitted light is predominantly linearly polarized parallel to high contrast grating bars, and reflected light is predominantly polarized perpendicular to the high contrast grating bars.

Further, as shown in FIG. 2, it is a schematic diagram of S-polarized light incident on the high-contrast grating polarizer according to an embodiment of the present disclosure, where the polarized light is incident on grating with angle ϑ, and the φ is equal to 90 deg. S-polarized light with φ equal to 90 deg means the E-field direction of light is parallel to grating. In this situation, when the light interacts with the high contrast grating 102, by designing the special period, duty cycle and thickness of grating, the reflection phase from grating's top and the reflection phase from grating's bottom are different, so it can realize the function to suppress the reflection of light. Meanwhile, since the E-field direction of light is parallel to grating, mostly there is air between grating, the metal has little influence on light, and mostly the S-polarized light with φ equal to 90 deg gets through the structure. As shown in FIG. 3, it is a schematic diagram of E-field simulation of S-polarized light with ϑ equal to 0 deg and φ equal to 90 deg according to an embodiment of the present disclosure, in which it can be seen that light passes through the grating.

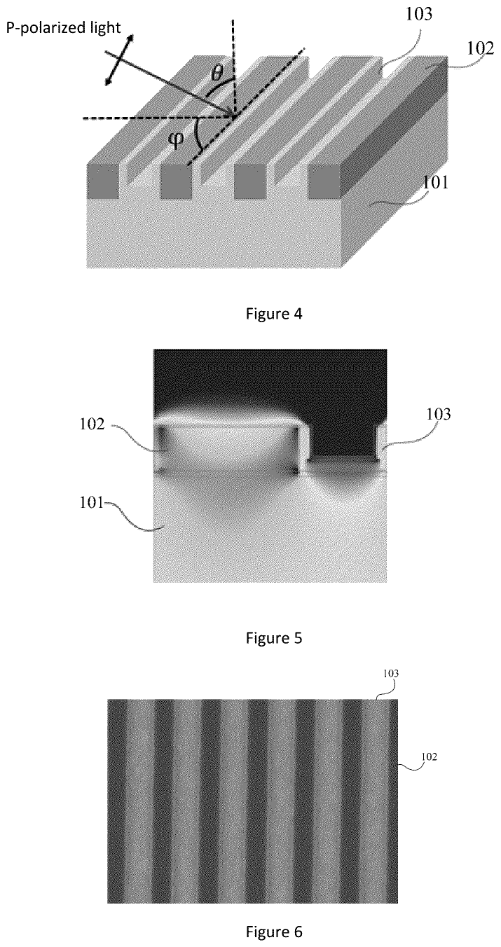

As shown in FIG. 4, it is a schematic diagram of P-polarized light incident on the high-contrast grating polarizer according to an embodiment of the present disclosure, where the polarized light is incident on grating with angle ϑ, and the φ is equal to 90 deg. P-polarized light with φ equal to 90 deg means the E-field direction of light is perpendicular to grating. In this situation, the light will have large interaction with the metal, especially the two sidewalls. The E-field can't penetrate the metal so it will get reflected. Both sidewalls have reflected E-field, so the two E-fields will interfere with each other to make the cavity work as an antenna resonator. At last, the light is reflected away, and it can't pass through the structure. As shown in FIG. 5, it is a schematic diagram of E-field simulation of P-polarized light with ϑ equal to 0 deg and φ equal to 90 deg according to an embodiment of the present disclosure, in which it can be seen that light can't pass through the grating.

It should be noted that the substrate 101 in the embodiment of the present disclosure may be made of one or more materials substantially transparent at the working wavelength of the polarizer. For example, the working wavelength includes, but is not limited to, EUV (extreme ultraviolet), DUV (deep ultraviolet), UV (ultraviolet), VIS (visible), NIR (near infrared), MIR (mid infrared), FIR (far infrared), THz (terahertz), or the like. The materials include, but are not limited to, SiO₂ (silicon dioxide), Al₂O₃ (aluminum oxide), Si (silicon), etc. Alternatively, the substrate 101 may be various types of glasses, amorphous, polycrystalline, crystalline substrates, etc. The high contrast grating 102 includes, but is not limited to, a semiconductor grating or a dielectric grating, and is made of, for example, Si (silicon), SiN (silicon nitride), Al₂O₃ (aluminum oxide), or any other kind of non-conductive material. The plasmonic metal antenna structure 103 may be any kind of metal, such as Au (gold), Ag (silver), Al (aluminum), Fe (iron), alloy, or other conductive material.

The high contrast grating polarizer 100 in some embodiments of the present disclosure may be a periodic structure or aperiodic structure. In other embodiments of the present disclosure, the high contrast grating polarizer 100 may be one-dimensional structure or two-dimensional structure.

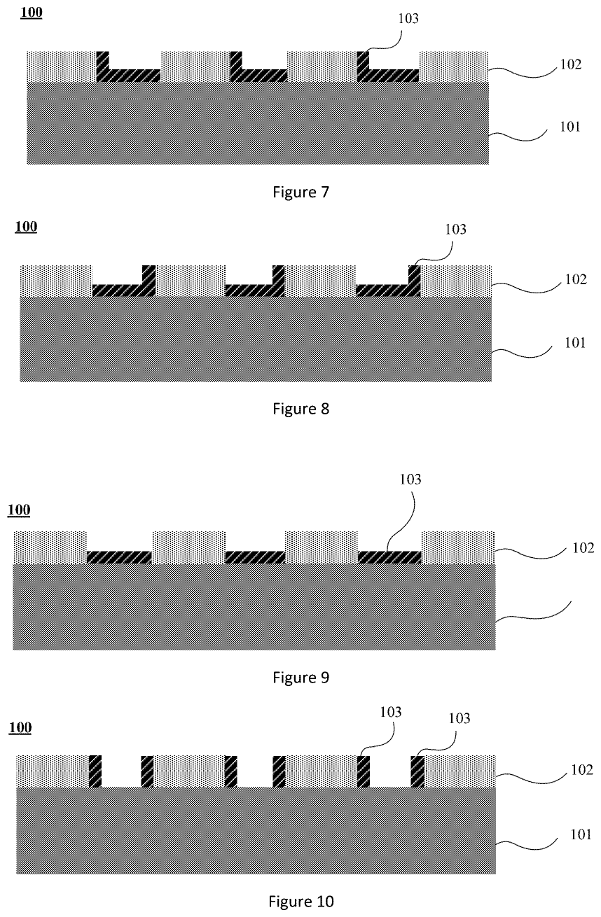

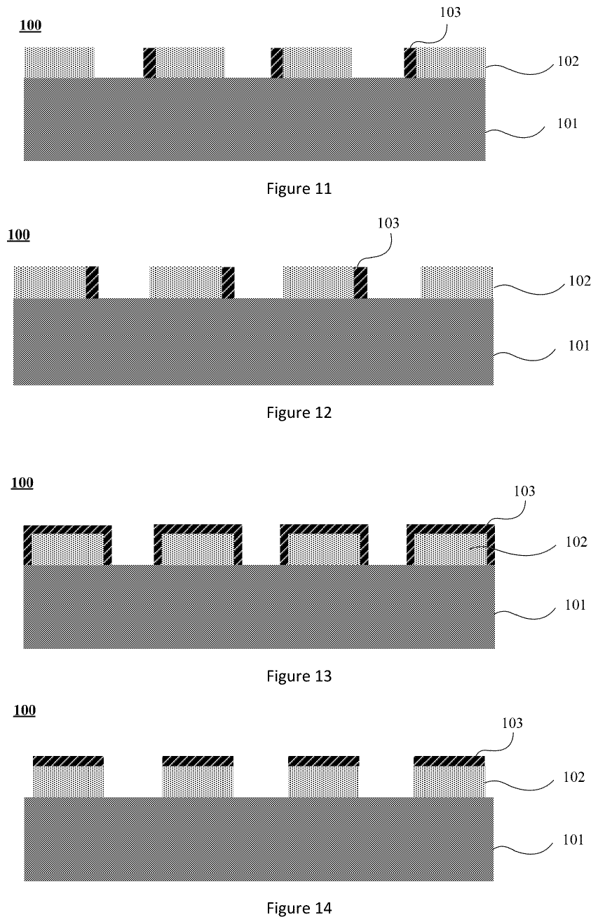

Exemplarily, the plasmonic metal antenna structure 103 in the embodiment of the present disclosure will be described in detail below. For example, the plasmonic metal antenna structure 103 is located in at least one of the bottom, left sidewall and right sidewall of a high contrast grating gap. As shown in FIG. 1, the plasmonic metal antenna structure 103 is located on the bottom, left sidewall and right sidewall of the high contrast grating gap. FIG. 6 shows an electron microscope image of a polarizer according to an embodiment of the present disclosure, where the dark area represents the high contrast grating 102 and the bright area represents the plasmonic metal antenna structure 103. As shown in FIG. 7, the plasmonic metal antenna structure 103 is located on the bottom and left sidewall of the high contrast grating gap. As shown in FIG. 8, the plasmonic metal antenna structure 103 is located on the bottom and right sidewall of the high contrast grating gap. As shown in FIG. 9, the plasmonic metal antenna structure 103 is located on the bottom of the high contrast grating gap. As shown in FIG. 10, the plasmonic metal antenna structure 103 is located on the left sidewall and right sidewall of the high contrast grating gap. As shown in FIG. 11, the plasmonic metal antenna structure 103 is located on the left sidewall of the high contrast grating gap. As shown in FIG. 12, the plasmonic metal antenna structure 103 is located on the right sidewall of the high contrast grating gap.

For another example, the plasmonic metal antenna structure 103 shown in FIG. 13 is located on the top, left sidewall and right sidewall of each high contrast grating bar. Alternatively, the plasmonic metal antenna structure 103 shown in FIG. 14 is located on the top of each high contrast grating bar.

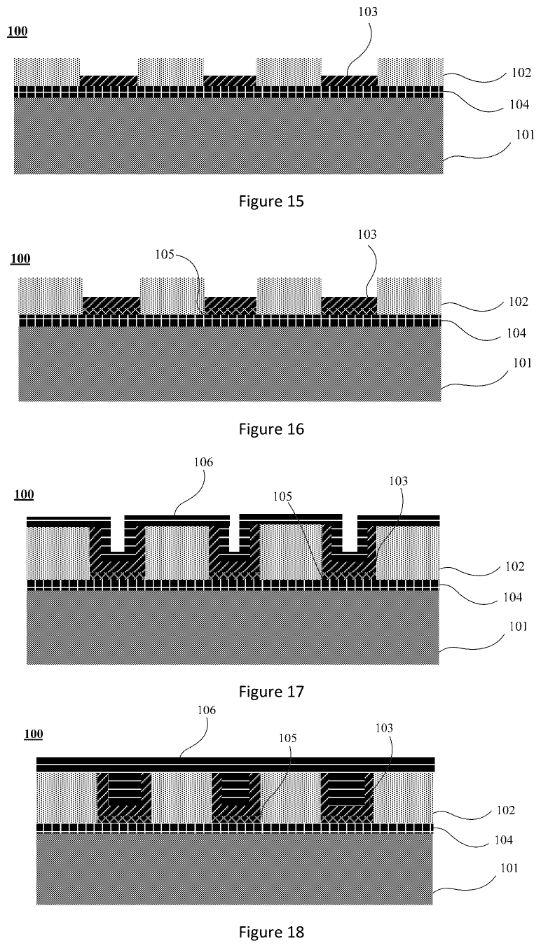

In some embodiments of the present disclosure, a first adhesive layer 104 is further provided between the substrate 101 and the high contrast grating 102, and/or between the substrate 101 and the plasmonic metal antenna structure 103, thereby enhancing the adhesion of the high contrast grating 102. As shown in FIG. 15, a first adhesive layer 104 is provided between the substrate 101 and the high contrast grating 102, and between the substrate 101 and the plasmonic metal antenna structure 103. The first adhesive layer 104 may include any one of a SiN layer, an Al₂O₃ layer, and a SiO₂ layer. During actual production, the first adhesive layer 104 may be deposited by methods like ALD (Atomic Layer Deposition), PECVD (Plasma Enhanced Chemical Vapor Deposition), CVD (Chemical Vapor Deposition), PVD (Physical Vapor Deposition), and others.

In some embodiments of the present disclosure, a second adhesive layer 105 is further provided between the plasmonic metal antenna structure 103 and the high contrast grating 102, and/or between the plasmonic metal antenna structure 103 and the first adhesive layer 104, thereby enhancing the adhesion of the metal surface. As shown in FIG. 16, a second adhesive layer 105 is provided between the plasmonic metal antenna structure 103 and the first adhesive layer 104. The second adhesive layer 105 may include any one of a Ti (titanium) layer, a Ge (germanium) layer, and an Al (aluminum) layer. During actual production, the second adhesive layer 105 may be deposited by methods such as ALD, PECVD, CVD, PVD, sputter and others.

As shown in FIG. 17, the outer surface of the high contrast grating 102 and the outer surface of the plasmonic metal antenna structure 103 in some embodiments of the present disclosure are covered with a protective layer 106. In other embodiments of the present disclosure, grooves of the plasmonic metal antenna structure 103 and/or grooves formed by gaps between the plasmonic metal antenna structure 103 and high contrast grating gaps as shown in FIG. 18 are further filled with the protective layer 106 respectively, which can protect the entire polarizer surface, extend its service life, and achieve strong reliability. For example, the protective layer may include any one of a SiN layer, an Al₂O₃ layer, and a SiO₂ layer, and may be deposited by methods such as ALD, PECVD, CVD, PVD and others.

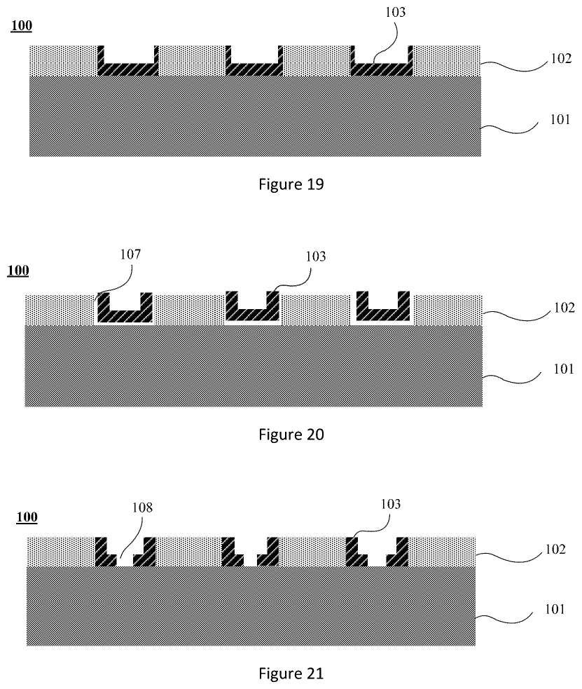

It should also be noted that, as shown in FIG. 19, the metal adjacent to one grating sidewall, the metal adjacent to the other grating sidewall, the metal on the bottom of the grating gap, and the metal on the top of the grating in an embodiment of the present disclosure may have different thicknesses. In the polarizer in which the plasmonic metal antenna structure 103 is located on the bottom, left sidewall and right side wall of the high contrast grating gap, a ratio of thicknesses of sidewall metal thickness divided by bottom metal thickness may be larger than 0.2 and less than 3. As shown in FIG. 20, there may be a gap 107 between the metal and the high contrast grating 102, and/or between the metal and the substrate 101. The gap 107 should be less than 30 nm. As shown in FIG. 21, there may be discontinuities in the metal layer, namely, there are air holes 108, and the size of such discontinuities should be smaller than the distance between two gratings.

The embodiments of the present disclosure provide a high contrast grating polarizer, in which the high contrast grating is made by semiconductor or dielectric material to replace most metal materials, so the production cost can be greatly decreased; and the plasmonic metal antenna structure interleaved with the high contrast grating can also reduce the grating thickness, so the structure is simple, the fabrication is easy, and meanwhile, the performance is still very close to the traditional wire-grid polarizer.

Finally, it should be noted that the foregoing embodiments are merely used to describe, but not to limit, the technical solutions of the present disclosure. Although the present disclosure is described in detail with reference to the foregoing embodiments, those of ordinary skill in the art should understand that they may still modify the technical solutions described in the foregoing embodiments, or equivalently substitute some technical features therein, and these modifications or substitutions do not make the essences of the corresponding technical solutions depart from the spirit and scope of the technical solutions of the embodiments of the present disclosure.

What is claimed is:

1. A high contrast grating polarizer, comprising:
a substrate; and
a high contrast grating on the substrate and a plasmonic metal antenna structure interleaved with the high contrast grating, wherein the high contrast grating comprises a semiconductor grating or a dielectric grating; and the high contrast grating is configured to transmit light of a first polarization direction, the plasmonic metal antenna structure is configured to reflect light of a second polarization direction, and the first polarization direction is opposite to the second polarization direction.

2. The polarizer according to claim 1, wherein the plasmonic metal antenna structure is located in at least one of the bottom, left sidewall and right sidewall of a high contrast grating gap.

3. The polarizer according to claim 1, wherein the plasmonic metal antenna structure is located on at least one of the top, left sidewall and right sidewall of each high contrast grating bar; or the plasmonic metal antenna structure is located on the top of each high contrast grating bar.

4. The polarizer according to claim 1, wherein a first adhesive layer is further provided between the substrate and the high contrast grating, and/or between the substrate and the plasmonic metal antenna structure.

5. The polarizer according to claim 4, wherein the first adhesive layer comprises any one of a SiN layer, an Al₂O₃ layer, and a SiO₂ layer.

6. The polarizer according to claim 4, wherein a second adhesive layer is further provided between the plasmonic metal antenna structure and the high contrast grating, and/or between the plasmonic metal antenna structure and the first adhesive layer.

7. The polarizer according to claim 6, wherein the second adhesive layer comprises any one of a Ti layer, a Ge layer, and an Al layer.

8. The polarizer according to claim 6, wherein the outer surface of the high contrast grating and the outer surface of the plasmonic metal antenna structure are covered with a protective layer.

9. The polarizer according to claim 8, wherein grooves of the plasmonic metal antenna structure and/or grooves formed by gaps between the plasmonic metal antenna structure and the high contrast grating are further filled with the protective layer, respectively.

10. The polarizer according to claim 8, wherein the protective layer comprises any one of a SiN layer, an Al₂O₃ layer, and a SiO₂ layer.
